(19) United States
(12) Patent Application Publication
(10) Pub. No.: US 2020/0366670 A1
(43) Pub. Date: Nov. 19, 2020

(54) A SYSTEM AND METHOD FOR AUTHENTICATING A USER

(71) Applicants: Peter Alexander CORDINER, Joostenberg Vlakte (ZA); Kenneth Grant METCALF, Strand (ZA)

(72) Inventors: Peter Alexander CORDINER, Joostenberg Vlakte (ZA); Kenneth Grant METCALF, Strand (ZA)

(21) Appl. No.: 16/642,056

(22) PCT Filed: Sep. 11, 2018
(86) PCT No.: PCT/IB2018/056922

§ 371 Date: Feb. 26, 2020

(30) Foreign Application Priority Data
Sep. 12, 2017 (ZA) 2017/06179

(51) Int. Cl. H04L 29/06; G06K 9/00; G06T 11/60; H04W 12/00; H04W 12/06

(52) U.S. Cl. CPC H04L 63/0861; G06K 9/00362; H04L 67/38; H04W 12/06; G06T 11/60; H04L 63/107; H04W 12/00503; G06K 9/0004

(57) ABSTRACT

A method and system for authenticating a user (106) at a predetermined geographical location are provided. The method is conducted at a mobile device (104) and includes receiving (212) a set of data elements from an authentication server (102). The set of data elements relates to an augmented reality object configured for superimposition on image data which is obtained (214) from a camera of the mobile device (104). The image data relates to a physical environment in which the mobile device (104) is located. A composite view, in which the augmented reality object is superimposed on the image data, is displayed (216) on the display of the mobile device (104). User interaction data relating to user interaction with the augmented reality object is recorded (218) and transmitted (219) to the authentication server. The user interaction data is analysed and compared with an expected interaction for authentication of the user (106).

### CROSS-REFERENCE TO RELATED APPLICATIONS

This application claims priority from South African provisional patent application number 2017/06179 filed on 12 Sep. 2017, which is incorporated by reference herein.

### FIELD OF THE INVENTION

This invention relates to a system and method for authenticating a user.

### BACKGROUND TO THE INVENTION

“Multi-factor authentication” typically refers to a security system that requires more than one method of authentication from independent categories of credentials to verify a user's identity for a transaction. The categories of credentials, or factors, typically include two or more of knowledge (something I know, such as a PIN), possession (something I have, such as a registered device) and inherence (something I am, such as biometric information).

Increasingly, geographical location is being used as an authentication factor, where for example a mobile device's geographical location, determined using a built-in GPS sensor, is compared with an expected location as a part of the authentication process. The inclusion of this factor aims to ensure that the user is in a specified and/or expected location when authenticating him- or herself.

The premise on which use of multiple authentication factors is based may be that an unscrupulous third party is unlikely to be able to supply correctly the multiple factors required for authentication. Typically, if at least one of the factors is missing or supplied incorrectly, authentication will be unsuccessful.

While multi-factor authentication may improve authentication security, there remain vulnerabilities. For example, PIN codes can be guessed or obtained through phishing or other devious means; registered devices can be stolen or imitated by spurious devices; it is further not impossible to generate fake inherence-related data; and, geographical location data can be obtained if it is known from where authentication is required to be performed. Individual factors are accordingly each associated with vulnerabilities which may make multi-factor authentication susceptible to compromise in the event of a well-executed attack.

Thus, although multi-factor authentication presents a step-forward in authentication processes, there remains scope for improvement.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with an aspect of the invention there is provided a computer-implemented method for authenticating a user, the method conducted at a mobile device of the user comprising: receiving a set of data elements from an authentication server, the set of data elements relating to an augmented reality object configured for superimposition on image data obtained from a camera of the mobile device; obtaining image data from the camera, the image data relating to a physical environment in which the mobile device is located; displaying a composite view on the display of the mobile device in which the augmented reality object is superimposed on the image data; recording user interaction data relating to user interaction with the augmented reality object; and, transmitting the user interaction data to the authentication server for validity analysis including comparison with an expected interaction for authentication of the user.

A further feature provides for recording user interaction data to include: identifying a body part of the user in the image data; monitoring movement of the identified body part; mapping the movement of the body part to manipulation of the augmented reality object being superimposed on the image data; and, recording the manipulation of the object.

Still further features provide for the interaction data to include the image data and for a physical object to be present in the physical environment which is required to be included in the image data for authentication of the user.

Yet further features provide for the camera to include a digital fingerprint which is uniquely associated with the user, and for the image data to include the digital fingerprint.

A further feature provides for the method to include: obtaining geographical location data relating to a geographical location of the mobile device from a geographical location element associated therewith; and, transmitting the geographical location data to the authentication server for determining whether the mobile device is within a predetermined threshold of a predetermined geographical location, and wherein, the set of data elements is only received if the mobile device is within the predetermined threshold of the predetermined geographical location.

Even further features provide for the augmented reality object to be a keypad and for user interaction with the augmented reality object to include inputting a passcode into the keypad.

In accordance with a further aspect of the invention there is provided a computer-implemented method for authenticating a user, the method conducted at an authentication server comprising: transmitting a set of data elements to a mobile device of the user, the set of data elements relating to an augmented reality object configured for superimposition on image data obtained from a camera of the mobile device; receiving user interaction data from the mobile device, the user interaction data relating to user interaction with the augmented reality object displayed in a composite view on a display of the mobile device in which the augmented reality object is superimposed on the image data; analysing the validity of the received user interaction data including comparing the received user interaction data with an expected interaction; and, if the received user interaction data is valid, authenticating the user.

A further feature provides for the user interaction data to include a recording of manipulation of the augmented reality object based on a mapping of movement of a body part of the user, identified in the image data, to manipulation of the augmented reality object being superimposed on the image data; and, for analysing the validity of the received user interaction data to include analysing one or both of biometric and physical data associated with the body part and included in the image data.

A yet further feature provides for authentication of the user to be associated with a predetermined physical environment.

Further features provide for the interaction data to include the image data; for analysing the validity of the user interaction data to include analysing the image data for the presence of a physical object which is known to be present in the physical environment which is required to be included in the image data for authentication of the user; and, for analysing the validity of the received user interaction data to include analysing the image data for the presence of a fingerprint included in a camera with which the image data is obtained, wherein the fingerprint is uniquely associated with the user.

Yet further features provide for the set of data elements to be transmitted to the mobile device of the user if the mobile device is determined to be within a predetermined threshold of a predetermined geographical location, and for the method to include: receiving geographical location data from the mobile device; and, using the geographical location data to determine whether the mobile device is within the predetermined threshold of the predetermined geographical location.

Even further features provide for the augmented reality object to be a keypad, for user interaction with the augmented reality object to include inputting a passcode into the keypad, and for comparing the received user interaction data with an expected interaction to include: analysing the user interaction data to determine the passcode input by the user; and, comparing the passcode to a passcode registered in association with the user.

In accordance with a further aspect of the invention there is provided a system for authenticating a user, the system including a mobile device of the user having a memory for storing computer-readable program code and a processor for executing the computer-readable program code, the mobile device comprising: a data element receiving component for receiving a set of data elements from an authentication server, the set of data elements relating to an augmented reality object configured for superimposition on image data obtained from a camera of the mobile device; an image data obtaining component for obtaining image data from the camera, the image data relating to a physical environment in which the mobile device is located; a composite view display component for displaying a composite view on the display of the mobile device in which the augmented reality object is superimposed on the image data; a user interaction data recording component for recording user interaction data relating to user interaction with the augmented reality object; and, a user interaction data transmitting component for transmitting the user interaction data to the authentication server for validity analysis including comparison with an expected interaction for authentication of the user.

In accordance with a further aspect of the invention there is provided a system for authenticating a user, the system including an authentication server having a memory for storing computer-readable program code and a processor for executing the computer-readable program code, the authentication server comprising: a data element transmitting component for transmitting a set of data elements to a mobile device of the user, the set of data elements relating to an augmented reality object configured for superimposition on image data obtained from a camera of the mobile device; a user interaction data receiving component for receiving user interaction data from the mobile device, the user interaction data relating to user interaction with the augmented reality object displayed in a composite view on a display of the mobile device in which the augmented reality object is superimposed on the image data; a validity analysing component for analysing the validity of the received user interaction data including comparing the received user interaction data with an expected interaction; and, a user authentication component for, if the received user interaction data is valid, authenticating the user.

In accordance with a further aspect of the invention there is provided a computer program product for authenticating a user, the computer program product comprising a computer-readable medium having stored computer-readable program code for performing the steps of: receiving a set of data elements from an authentication server, the set of data elements relating to an augmented reality object configured for superimposition on image data obtained from a camera of the mobile device; obtaining image data from the camera, the image data relating to a physical environment in which the mobile device is located; displaying a composite view on the display of the mobile device in which the augmented reality object is superimposed on the image data; recording user interaction data relating to user interaction with the augmented reality object; and, transmitting the user interaction data to the authentication server for validity analysis including comparison with an expected interaction for authentication of the user.

In accordance with a further aspect of the invention there is provided a computer program product for authenticating a user, the computer program product comprising a computer-readable medium having stored computer-readable program code for performing the steps of: transmitting a set of data elements to a mobile device of the user, the set of data elements relating to an augmented reality object configured for superimposition on image data obtained from a camera of the mobile device; receiving user interaction data from the mobile device, the user interaction data relating to user interaction with the augmented reality object displayed in a composite view on a display of the mobile device in which the augmented reality object is superimposed on the image data; analysing the validity of the received user interaction data including comparing the received user interaction data with an expected interaction; and, if the received user interaction data is valid, authenticating the user.

Further features provide for the computer-readable medium to be a non-transitory computer-readable medium and for the computer-readable program code to be executable by a processing circuit.

An embodiment of the invention will now be described, by way of example only, with reference to the accompanying drawings.

### BRIEF DESCRIPTION OF THE DRAWINGS

In the drawings:

FIG. 1 is a schematic diagram which illustrates an exemplary system for authenticating a user;

FIG. 2 is a swim-lane flow diagram which illustrates an exemplary method for authenticating a user;

FIG. 3 is a schematic diagram which illustrates an example user interaction with an augmented reality object described herein;

FIG. 4 is a block diagram which illustrates exemplary components which may be provided by a system for authenticating a user; and,

FIG. 5 illustrates an example of a computing device in which various aspects of the disclosure may be implemented.

### DETAILED DESCRIPTION WITH REFERENCE TO THE DRAWINGS

Aspects of this disclosure are directed towards authentication of a user wishing to conduct a transaction. Exemplary transactions include gaining access to physical resources (e.g. unlocking a safe door) and gaining access to online resources (e.g. cloud-based infrastructure, internet banking facility, etc.).

In particular, aspects of this disclosure may relate to authentication of a user at a predetermined geographical location. A system and method are described which provide augmented reality (AR) objects for manipulation by users in predetermined fashions in order to authenticate the users. Each user may be provided with a different AR object for manipulation and/or may be required to manipulate the AR object in a different way. In some cases, manipulation of the AR objects may be inextricably tied to other authentication factors, such as one or more of geographical location-, biometric- and device-based authentication factors. This may entail linking credentials associated with each of these authentication factors together in a single data construct such that they cannot be nefariously obtained or guessed independently. The AR objects may take on any suitable form. Exemplary AR objects include a keypad configured for entry of a passcode, a three-dimensional object which is required to be orientated in a specific fashion, a rotary combination lock via which a passcode can be input, on object on which a passcode is hidden where the object is required to be explored by the user in order to find the passcode, and the like.

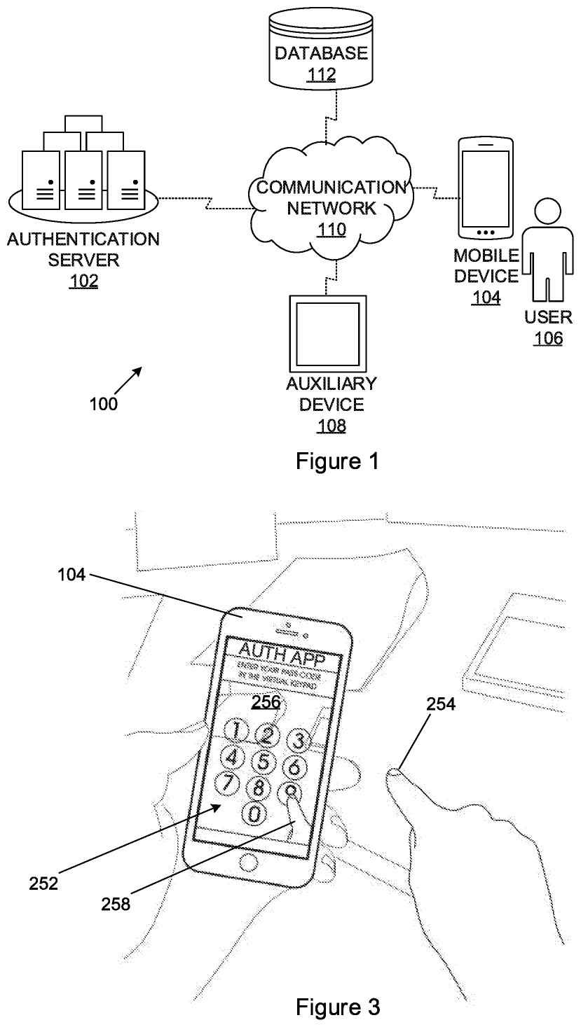

FIG. 1 is a schematic diagram which illustrates an exemplary system (100) for authenticating a user. The system (100) may include an authentication server (102) and a mobile device (104) associated with a user (106). In some implementations, the system may include an auxiliary device (108) which is used in the authentication process. The authentication server (102), mobile device (104) and optionally the auxiliary device (108) may be configured to communicate on a suitable communication network (110), such as the Internet. In this manner, the authentication server (102) may exchange data and/or messages with the mobile device (104) and optionally the auxiliary device (108), and vice versa. In some cases, communications on the communication network may be secured (e.g. using SSL, IPSec, etc.).

The authentication server (102) may be any suitable computing device configured to perform a server role. The authentication server (102) may have access to a database (112) in which a record associated with the user (106) may be stored. The record may include authentication information associated with the user (106), such as one or more of the following: times at which the user is permitted to request authentication; locations from which the user is permitted to request authentication; an identifier of the mobile device (104) associated with the user and from which the user is permitted to request authentication; one or more AR objects with which the user is expected to interact with in a predetermined fashion in order to authenticate him- or herself; expected interactions associated with each of the AR objects; biometric information associated with the user (e.g. fingerprints, venous patterns visible on the user's hands, palm prints, etc.); and the like.

The authentication server (102) may be configured to provide an AR object to the mobile device (104) for presentation to the user (106). The authentication server (102) may be configured to expect the user (106) to interact with the AR object in a predetermined and/or pre-agreed fashion and, via the mobile device (104), may monitor the user's interaction with the AR object to determine whether the user interacts with the AR object correctly.

The mobile device (104) may be any suitable portable computing device which is configured to communicate with the authentication server (102) via the communication network (110). Exemplary mobile devices include mobile phones (e.g. smartphones), tablet computers, wearable computing devices, augmented reality devices (e.g. an optical head-mounted display), virtual reality (VR) devices (e.g. VR headsets) and the like.

The mobile device (104) may be associated with a unique identifier and may be uniquely associated with the user (106). The mobile device (104) may identify itself to the authentication server (102) using its unique identifier. In some implementations, the mobile device (104) may include a camera which has a digital fingerprint encoded therein. The digital fingerprint may be hardcoded into one or more of the camera components such that any image data output by the camera includes the digital fingerprint. In some cases, for example, the digital fingerprint may be provided on the camera lens so as to be present in the image data obtained by the camera.

As will be explained in greater detail below, the mobile device (104) may be configured to render and display AR objects which are configured for manipulation by the user (106) in a predetermined, pre-agreed fashion for analysis by the authentication server (102) in the course of authenticating the user (106).

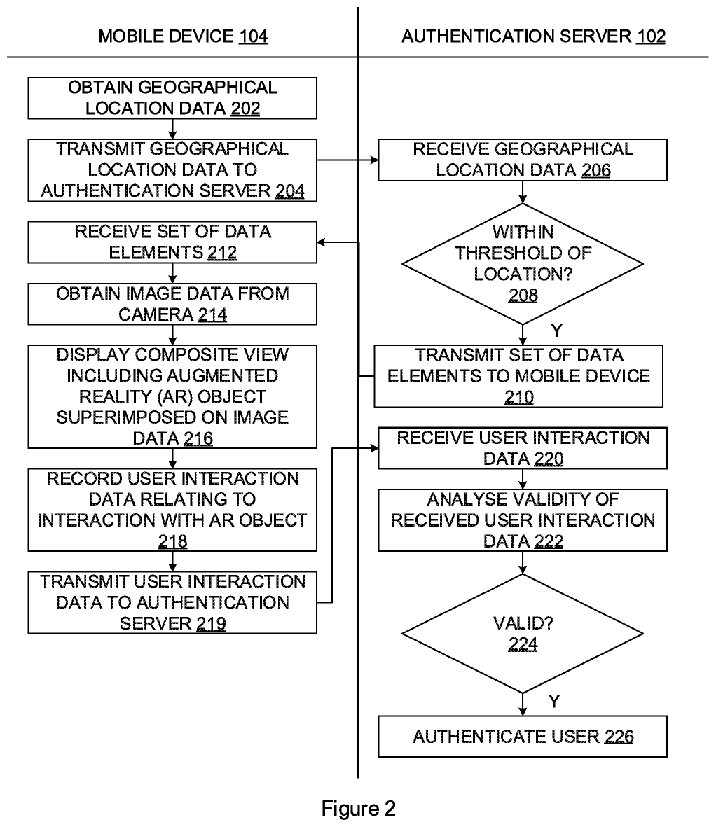

The system (100) described above may implement a method for authenticating a user. An exemplary method for authenticating a user is illustrated in the swim-lane flow diagram of FIG. 2, in which respective swim-lanes delineate steps, operations or procedures performed by respective entities or devices.

For the purpose of illustration, the method is described with reference to an exemplary scenario in which a user wishes to open a door to a safe. It should however be appreciated that the described method can be extended to any suitable transaction scenario in which a user is required to authenticate him- or herself before being permitted to conduct the transaction.

The user may travel to the safe and, when standing in front of the door or otherwise suitably close, may launch an authentication software application executing on the mobile device (104). The mobile device (104) may obtain (202) geographical location data associated with a geographical location of the mobile device (104). The geographical location data may be obtained from a geographical location element associated with the mobile device (104).

The mobile device (104) may transmit (204) the geographical location data to the authentication server (102) for determining whether the mobile device is within a predetermined threshold of a predetermined geographical location. The predetermined geographical location may be the registered geographical location associated with the safe and the predetermined threshold may be a selected radius extending from the predetermined geographical location and within which the user may be considered close enough to the predetermined geographical location in order to be able to request authentication. In some implementations, the mobile device (104) may transmit a unique identifier associated therewith to the authentication server (102) so that the authentication server (102) can identify the mobile device (104). The authentication server (102) may receive (206) the geographical location data from the mobile device (104).

The authentication server (102) may use the received geographical location data to determine (208) whether the mobile device is within the predetermined threshold of the predetermined geographical location. This may include querying the database (112) to determine whether the geographical location data matches geographical locations stored in the record associated with the mobile device (104). In some implementations, this may include checking a schedule to determine whether the mobile device (104) is permitted to be at the geographical location at the present time (i.e. at the time at which the geographical location data is received).

The authentication server (102) may transmit (210) a set of data elements to the mobile device (104) of the user. The set of data elements may relate to an augmented reality object which is configured for superimposition on image data obtained from a camera of the mobile device (104). In some implementations, the data elements may be configured to be combined with data securely stored in the mobile device such that an AR object which is unique to the mobile device (104) is rendered. In some implementations, the data elements are only transmitted to the mobile device if the mobile device is determined to be within a predetermined threshold of a predetermined geographical location.

The mobile device (104) may receive (212) the set of data elements from the authentication server (102). As mentioned, in some implementations, the set of data elements is only received if the mobile device is within the predetermined threshold of the predetermined geographical location.

The mobile device (104) may obtain (214) image data from the camera associated with the mobile device. The image data may relate to a physical environment in which the mobile device is located, in that aspects of the physical environment which fall within the field of view of the camera are included and recognisable in the image data. In some cases, a physical object may be present in the physical environment which is required to be included in the image data for authentication of the user. The physical object may be any suitable object, such as a graphical code, a unique object or, in some implementations, the auxiliary device (108). In some cases, for example, a token may be written on the door of the safe and is required to be included in the field of view of the camera. In other cases, the auxiliary device (108) may be built into or otherwise associated with the safe door and may be configured to display a dynamic token which is required to be included in the field of view of the camera.

The mobile device (104) may display (216) a composite view on the display of the mobile device. The composite view may include the augmented reality object superimposed on the image data. Displaying the composite view may include rendering the augmented reality object and displaying the rendered object in the image data. Rendering the object may include identifying planes in the image data and associating the object with selected planes (e.g. a floor plane or a wall plane). In some implementations, displaying (216) the composite view may include obtaining movement data from movement sensors (e.g. an accelerometer and/or gyroscope) associated with the mobile device and rendering and displaying a view of the augmented reality object which corresponds to the orientation of the mobile device. In this manner, the user may be able to move the mobile device (104) around to view the augmented reality object from different angles.

The mobile device (104) may record (218) user interaction data relating to user interaction with the augmented reality object. Recording (218) user interaction data may include identifying a body part (e.g. a hand or hands) of the user in the image data and monitoring movement of the identified body part. The mobile device (104) may map the movement of the body part to manipulation of the augmented reality object being superimposed on the image data and record the manipulation of the object. For example, the mobile device may recognise selected actions, such as grabbing, rotating, touching, moving, etc. and calculate how the recognised action would affect the augmented reality object. The mobile device may update the rendering and display of the augmented reality object in accordance with the effect the action is calculated to have on the object. Monitoring user interaction with the AR object and updating rendering and display of the AR object may use techniques which are known in the art.

In this manner, the user (106) may be able to interact with the augmented reality object as if the object were a real, physical object. The user may interact with the augmented reality object by viewing the object through the display of the mobile device and then position the user's hand behind the mobile device and within the field of view of the camera so that the user can see the user's hand in the composite view and interact with the augmented reality object as if it were a physical object.

As mentioned, in some implementations, the user (106) may be required to include the physical object in the field of view of the camera so that the physical object is visible in the image data. The physical object may be configured to detection and analysis by the authentication server to validate that the user is manipulating the augmented reality object at the predetermined location.

Further, in some implementations, the camera may include a digital fingerprint which is uniquely associated with the user (106) and/or the mobile device (104). The digital fingerprint may be hard coded into components of the camera so that it is included in any image data which is output by the camera. For example, in some implementations, the digital fingerprint may be in the form of a watermark which is provided on a lens of the camera and which accordingly appears in the image data for validation by the authentication server (102).

In this example embodiment, the augmented reality object may be a keypad and user interaction with the augmented reality object may include inputting a passcode into the keypad. Input of the passcode may be captured by the camera and included in user interaction data, as opposed to being input using a touch-sensitive display.

In some cases, the mobile device (104) may obtain biometric information while recording the user interaction data. This may be by way of high resolution images in which biometric information, such as fingerprints, palm prints, hand venous patterns and the like, may be identified and verified against the record stored in the database (112).

Recording (218) user interaction data relating to user interaction with the augmented reality object may include recoding a video for analysis by the authentication server. In some cases, recording user interaction may take screenshots of the composite display at predefined periods. In other cases recording the user interaction may store data associated with the updated rendering and/or display of the AR object from which the user's manipulation can be recreated. The user interaction data may include image data which may in turn include one or more of: a representation of a physical object associated with the physical environment and/or geographical location; biometric information usable in identifying the user (106); a digital fingerprint which is uniquely associated with the mobile device (104) and/or the user (106); and, information which can be mapped to user interaction with the augmented reality object.

The mobile device (104) may transmit (219) the user interaction data to the authentication server (102) for comparison with an expected interaction for authentication of the user. The authentication server (102) may receive (220) the user interaction data from the mobile device (104). As mentioned, the user interaction data may relate to user interaction with the augmented reality object displayed in the composite view on the display of the mobile device (104). In some implementations, the user interaction data may be in the form of a video file.

The authentication server (102) may analyse (222) the validity of the received user interaction data. Analysing (222) the validity of the user interaction data may include comparing the received user interaction data with an expected interaction. As mentioned in the foregoing, in this exemplary embodiment, the augmented reality object may be a keypad and the user interaction with the augmented reality object may include inputting a passcode into the keypad. Comparing the received user interaction data with an expected interaction may include analysing the user interaction data to determine the passcode input by the user and comparing the passcode to a passcode registered in association with the user. This may include performing image processing on the received user interaction data in order to extract interaction information relating to how the augmented reality object was manipulated for comparison against an expected manipulation.

In some implementations, the user interaction data includes a recording of manipulation of the augmented reality object based on a mapping of movement of a body part of the user, identified in the image data, to manipulation of the augmented reality object being superimposed on the image data and analysing the validity of the user interaction data may include extracting the recording of manipulation.

FIG. 3 is a schematic diagram which illustrates an example in which a user interacts with an augmented reality object in an authentication software application executing on a mobile device (104) of a user (106). In this exemplary embodiment the augmented reality object is a keypad (252) and the user interaction data may include a mapping of movement of the user's body part (254) (e.g. an outstretched finger) to manipulation of the keypad (252) to identify a passcode that the user is ‘inputting’ into the keypad. The mapping may be achieved by performing image processing on image data (256) acquired by the camera. The image data may include body part image data (258) (being image data showing the body part) and the mapping may map terminal positions of the body part image data (258) to corresponding keys of the augmented reality keypad (252) being displayed on the mobile device (104) to identify which keys of the keypad are being pressed. Terminal positions of the body part image data (258) may correspond to positions of the body part (254) which would correspond to a button press before the body part is withdrawn away from the button. In the case of the body part being the user's finger, the terminal positions of the body part in the image data may be identified by the image processing algorithm as being those positions at which the tip of the user's finger is smallest in size and immediately before it starts increasing in size as the user removes the finger away from the ‘button’.

Analysing (222) the validity of the received user interaction data may include extracting and analysing biometric and/or physical data associated with a body part of the user (108). Analysing the biometric data may include comparing the extracted biometric data with biometric data stored in the record in association with the user (106) for a match. Analysing physical data may for example entail determining which of a left hand or right hand is used, identifying and analysing a pulse rate, detecting sweat and the like. In some implementations, for example, physical data could be analysed to identify duress. For example detecting sweat could be a sign of duress or, in some cases, the user may be trained to use his/her left hand when under duress and his/her right hand ordinarily.

In some implementations, analysing (222) the validity of the received user interaction data may include analysing the image data for the presence of a physical object which is known to be present in the physical environment and which is required to be included in the image data for authentication of the user. This may include performing image processing on the image data to identify and extract image data associated with the physical object and to compare the image data associated with the physical object with expected image data stored in association with the record. In some implementations, the physical object may be associated with a token which uniquely identifies the physical environment and/or the safe door and analysing the image data for the presence of the object may include extracting and validating the token.

Further, in some implementations, analysing (222) the validity of the received user interaction data may include analysing the image data for the presence of a digital fingerprint which is uniquely associated with the camera and hence the mobile device (104) and/or the user (108). This may include using image processing to detect and extract the digital fingerprint and comparing the extracted digital fingerprint with a digital fingerprint stored in the user record and/or registered in association with the mobile device (104).

If (224) the received user interaction data is valid, the authentication server (102) may authenticate (226) the user. Depending on the implementation, valid authentication data may include one or more of: a valid user interaction with the augmented reality object; valid biometric information included in the image data; a valid digital fingerprint included in the image data; and, a valid physical object and/or token included in the image data.

It should be appreciated that the user authentication data may accordingly include credentials associated with multiple categories of authentication in a single data construct. For example a single data construct may be analysed to extract and validate: knowledge information (knowledge on how to manipulate the augmented reality object); possession information (the digital fingerprint of the device which is uniquely associated with the user); location information (the presence of the physical object in the image data); and, inherence information (the biometric information identifiable in the image data). This may reduce opportunity for nefarious third parties to attempt to fraudulently authenticate themselves with the authentication server in that there is only one opportunity for all of the authentication factors to be present and correct.

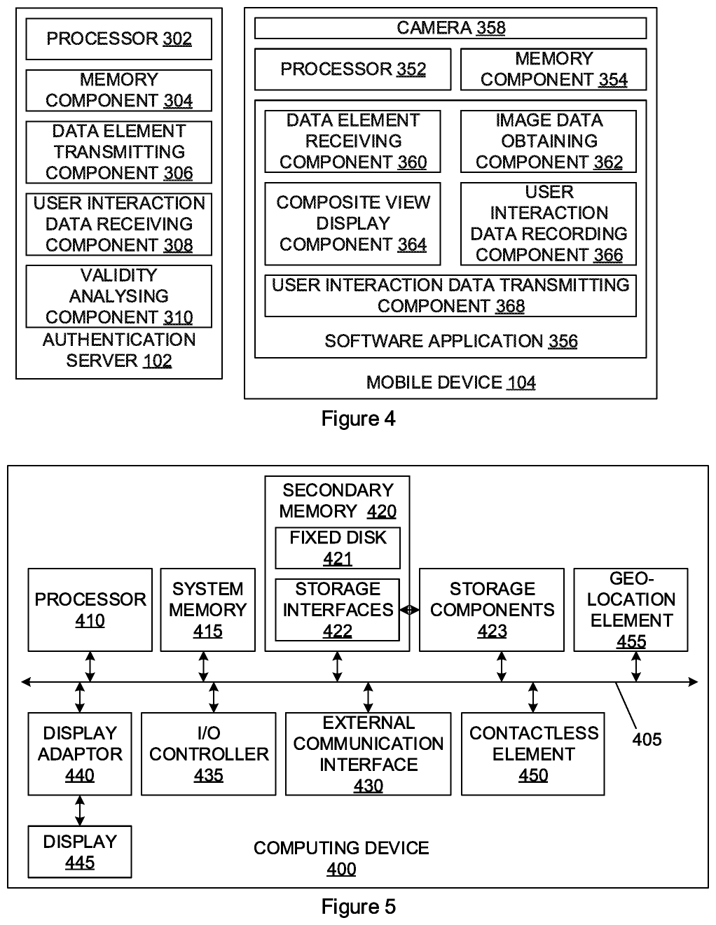

Various components may be provided for implementing the method described above with reference to FIG. 2. FIG. 4 is a block diagram which illustrates exemplary components which may be provided by a system for authenticating a user. The system includes the authentication server (102) and the mobile device (104).

The authentication server (102) may include a processor (302) for executing the functions of components described below, which may be provided by hardware or by software units executing on the authentication server (102). The software units may be stored in a memory component (304) and instructions may be provided to the processor (302) to carry out the functionality of the described components.

The authentication server (102) may include a data element transmitting component (306) arranged to transmit a set of data elements to a mobile device of the user. The set of data elements may relate to an augmented reality object configured for superimposition on image data obtained from a camera of the mobile device. The authentication server (102) may include a user interaction data receiving component (308) arranged to receive user interaction data from the mobile device. The user interaction data may relate to user interaction with the augmented reality object displayed in a composite view on a display of the mobile device in which the augmented reality object is superimposed on the image data. The authentication server (102) may include a validity analysing component (310) arranged to analyse the validity of the received user interaction data. This may include comparing the received user interaction data with an expected interaction. The authentication server (102) may include a user authentication component arranged to authenticate the user if the received user interaction data is valid.

The authentication server (102) may include further components arranged to provide further functionality of the authentication server described above with reference to FIG. 2.

The mobile device (104) may include a processor (352) for executing the functions of components described below, which may be provided by hardware or by software units executing on the mobile device (104). The software units may be stored in a memory component (354) and instructions may be provided to the processor (352) to carry out the functionality of the described components. In some cases, for example in a cloud computing implementation, software units arranged to manage and/or process data on behalf of the mobile device (104) may be provided remotely. Some or all of the components may be provided by a software application (356) downloadable onto and executable on the mobile device (104).

The mobile device (104) may include a camera (358) or cameras configured to obtain image data representing a physical environment in which the mobile device is located.

The software application (356) may include a data element receiving component (360) arranged to receive a set of data elements from the authentication server (102). The set of data elements may relate to an augmented reality object configured for superimposition on image data obtained from the camera (358) of the mobile device. The software application (356) may include an image data obtaining component (362) arranged to obtain image data from the camera (358). The image data may relate to a physical environment in which the mobile device (104) is located. The software application (356) may include a composite view display component (364) arranged to display a composite view on the display of the mobile device in which the augmented reality object is superimposed on the image data. The software application (356) may include a user interaction data recording component (366) arranged to record user interaction data relating to user interaction with the augmented reality object. The software application (356) may include a user interaction data transmitting component (368) arranged to transmit the user interaction data to the authentication server (102) for comparison with an expected interaction for authentication of the user.

The mobile device (104) and/or software application (356) may include further components arranged to provide further functionality of the mobile device (104) described above with reference to FIG. 2.

Aspects of this disclosure accordingly enable an AR object to be provided for manipulation by a user in a predetermined and/or pre-agreed fashion for authentication of the user. In some implementations, this manipulation is bound to other authentication factors, such as location, biometric and device credentials for validation and authentication of the user. As mentioned, the AR objects may take on any suitable forms and could be a keypad, a cube, a pot plant in which a unique code is hidden, a rotary combination lock and the like. Manipulation of the AR object is captured by the camera. In some implementations, user biometric information may be included in the field of view of the camera and combined with user interaction data which describes the manipulation of the AR object. In this manner, the camera may be used to identify the user by taking his fingerprint. Further, in some cases, duress may be detected by estimating the users pulse from the image data and comparing this to historic data to determine a likelihood that the user is under duress (e.g. that a nefarious third party is present and is forcing the user to authenticate him/herself). In other cases, duress may be signalled by the user by using his/her left hand as opposed to using his/her right hand, or vice versa.

Aspects of this disclosure may provide the advantage that by using AR, as opposed to the phone's keypad, for entry of a PIN or other passcode, the authentication server may be able to verify that the user is actually present at the lock when inputting the passcode. This verification could be achieved by analysing the image data obtained by the mobile device camera to extract information identifying the lock (or safe door) as well as the passcode information. Because the identifying information and passcode information are included in the same image data, they may be tied together. This may be helpful in preventing problems associated with existing authentication system in which spurious messages may be sent from remote locations which include known coordinates of the lock in order to purport to have been sent from the location of the lock (when in fact they are not).

Aspects of this disclosure provide for objects to appear to the user to be present in the physical environment, when in fact they are not. This may be based on a specific location. AR simulates three dimensions in space and may enable “realness” and presentation of objects that could be useful.

FIG. 5 illustrates an example of a computing device (400) in which various aspects of the disclosure may be implemented. The computing device (400) may be embodied as any form of data processing device including a personal computing device (e.g. laptop or desktop computer), a server computer (which may be self-contained, physically distributed over a number of locations), a client computer, or a communication device, such as a mobile phone (e.g. cellular telephone), satellite phone, tablet computer, personal digital assistant or the like. Different embodiments of the computing device may dictate the inclusion or exclusion of various components or subsystems described below.

The computing device (400) may be suitable for storing and executing computer program code. The various participants and elements in the previously described system diagrams may use any suitable number of subsystems or components of the computing device (400) to facilitate the functions described herein. The computing device (400) may include subsystems or components interconnected via a communication infrastructure (405) (for example, a communications bus, a network, etc.). The computing device (400) may include one or more processors (410) and at least one memory component in the form of computer-readable media. The one or more processors (410) may include one or more of: CPUs, graphical processing units (GPUs), microprocessors, field programmable gate arrays (FPGAs), application specific integrated circuits (ASICs) and the like. In some configurations, a number of processors may be provided and may be arranged to carry out calculations simultaneously. In some implementations various subsystems or components of the computing device (400) may be distributed over a number of physical locations (e.g. in a distributed, cluster or cloud-based computing configuration) and appropriate software units may be arranged to manage and/or process data on behalf of remote devices.

The memory components may include system memory (415), which may include read only memory (ROM) and random access memory (RAM). A basic input/output system (BIOS) may be stored in ROM. System software may be stored in the system memory (415) including operating system software. The memory components may also include secondary memory (420). The secondary memory (420) may include a fixed disk (421), such as a hard disk drive, and, optionally, one or more storage interfaces (422) for interfacing with storage components (423), such as removable storage components (e.g. magnetic tape, optical disk, flash memory drive, external hard drive, removable memory chip, etc.), network attached storage components (e.g. NAS drives), remote storage components (e.g. cloud-based storage) or the like.

The computing device (400) may include an external communications interface (430) for operation of the computing device (400) in a networked environment enabling transfer of data between multiple computing devices (400) and/or the Internet. Data transferred via the external communications interface (430) may be in the form of signals, which may be electronic, electromagnetic, optical, radio, or other types of signal. The external communications interface (430) may enable communication of data between the computing device (400) and other computing devices including servers and external storage facilities. Web services may be accessible by and/or from the computing device (400) via the communications interface (430).

The external communications interface (430) may be configured for connection to wireless communication channels (e.g., a cellular telephone network, wireless local area network (e.g. using Wi-Fi™), satellite-phone network, Satellite Internet Network, etc.) and may include an associated wireless transfer element, such as an antenna and associated circuitry. The external communications interface (430) may include a subscriber identity module (SIM) in the form of an integrated circuit that stores an international mobile subscriber identity and the related key used to identify and authenticate a subscriber using the computing device (400). One or more subscriber identity modules may be removable from or embedded in the computing device (400).

The external communications interface (430) may further include a contactless element (450), which is typically implemented in the form of a semiconductor chip (or other data storage element) with an associated wireless transfer element, such as an antenna. The contactless element (450) may be associated with (e.g., embedded within) the computing device (400) and data or control instructions transmitted via a cellular network may be applied to the contactless element (450) by means of a contactless element interface (not shown). The contactless element interface may function to permit the exchange of data and/or control instructions between computing device circuitry (and hence the cellular network) and the contactless element (450). The contactless element (450) may be capable of transferring and receiving data using a near field communications capability (or near field communications medium) typically in accordance with a standardized protocol or data transfer mechanism (e.g., ISO 14443/NFC). Near field communications capability may include a short-range communications capability, such as radio-frequency identification (RFID), Bluetooth™, infra-red, or other data transfer capability that can be used to exchange data between the computing device (400) and an interrogation device. Thus, the computing device (400) may be capable of communicating and transferring data and/or control instructions via both a cellular network and near field communications capability.

The computer-readable media in the form of the various memory components may provide storage of computer-executable instructions, data structures, program modules, software units and other data. A computer program product may be provided by a computer-readable medium having stored computer-readable program code executable by the central processor (410). A computer program product may be provided by a non-transient computer-readable medium, or may be provided via a signal or other transient means via the communications interface (430).

Interconnection via the communication infrastructure (405) allows the one or more processors (410) to communicate with each subsystem or component and to control the execution of instructions from the memory components, as well as the exchange of information between subsystems or components. Peripherals (such as printers, scanners, cameras, or the like) and input/output (I/O) devices (such as a mouse, touchpad, keyboard, microphone, touch-sensitive display, input buttons, speakers and the like) may couple to or be integrally formed with the computing device (400) either directly or via an I/O controller (435). One or more displays (445) (which may be touch-sensitive displays) may be coupled to or integrally formed with the computing device (400) via a display (445) or video adapter (440).

The computing device (400) may include a geographical location element (455) which is arranged to determine the geographical location of the computing device (400). The geographical location element (455) may for example be implemented by way of a global positioning system (GPS), or similar, receiver module. In some implementations the geographical location element (455) may implement an indoor positioning system, using for example communication channels such as cellular telephone or Wi-Fi™ networks and/or beacons (e.g. Bluetooth™ Low Energy (BLE) beacons, iBeacons™, etc.) to determine or approximate the geographical location of the computing device (400). In some implementations, the geographical location element (455) may implement inertial navigation to track and determine the geographical location of the communication device using an initial set point and inertial measurement data.

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

Any of the steps, operations, components or processes described herein may be performed or implemented with one or more hardware or software units, alone or in combination with other devices. In one embodiment, a software unit is implemented with a computer program product comprising a non-transient computer-readable medium containing computer program code, which can be executed by a processor for performing any or all of the steps, operations, or processes described. Software units or functions described in this application may be implemented as computer program code using any suitable computer language such as, for example, C #, Java™, C++, or Perl™ using, for example, conventional or object-oriented techniques. The computer program code may be stored as a series of instructions, or commands on a non-transitory computer-readable medium, such as a random access memory (RAM), a read-only memory (ROM), a magnetic medium such as a hard-drive, or an optical medium such as a CD-ROM. Any such computer-readable medium may also reside on or within a single computational apparatus, and may be present on or within different computational apparatuses within a system or network.

Flowchart illustrations and block diagrams of methods, systems, and computer program products according to embodiments are used herein. Each block of the flowchart illustrations and/or block diagrams, and combinations of blocks in the flowchart illustrations and/or block diagrams, may provide functions which may be implemented by computer readable program instructions. In some alternative implementations, the functions identified by the blocks may take place in a different order to that shown in the flowchart illustrations.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

Finally, throughout the specification and claims unless the contents requires otherwise the word ‘comprise’ or variations such as ‘comprises’ or ‘comprising’ will be understood to imply the inclusion of a stated integer or group of integers but not the exclusion of any other integer or group of integers.

1. A computer-implemented method for authenticating a user, the method conducted at a mobile device of the user comprising:
receiving a set of data elements from an authentication server, the set of data elements relating to an augmented reality object configured for superimposition on image data obtained from a camera of the mobile device;
obtaining image data from the camera, the image data relating to a physical environment in which the mobile device is located;
displaying a composite view on the display of the mobile device in which the augmented reality object is superimposed on the image data;
recording user interaction data relating to user interaction with the augmented reality object; and,
transmitting the user interaction data to the authentication server for validity analysis including comparison with an expected interaction for authentication of the user.

2. The method as claimed in claim 1, wherein recording user interaction data includes: identifying a body part of the user in the image data;
monitoring movement of the identified body part;
mapping the movement of the body part to manipulation of the augmented reality object being superimposed on the image data; and,
recording the manipulation of the object.

3. The method as claimed in claim 1, wherein the interaction data includes the image data.

4. The method as claimed in claim 1, wherein a physical object is present in the physical environment which is required to be included in the image data for authentication of the user.

5. The method as claimed in claim 1, wherein the camera includes a digital fingerprint which is uniquely associated with the user.

6. The method as claimed in claim 5, wherein the image data includes the digital fingerprint.

7. The method as claimed in claim 1, wherein the method includes: obtaining geographical location data relating to a geographical location of the mobile device from a geographical location element associated therewith; and,
transmitting the geographical location data to the authentication server for determining whether the mobile device is within a predetermined threshold of a predetermined geographical location;
and wherein, the set of data elements is only received if the mobile device is within the predetermined threshold of the predetermined geographical location.

8. The method as claimed in claim 1, wherein the augmented reality object is a keypad and user interaction with the augmented reality object includes inputting a passcode into the keypad.

9. (canceled)

10. A computer-implemented method for authenticating a user, the method conducted at an authentication server comprising:
transmitting a set of data elements to a mobile device of the user, the set of data elements relating to an augmented reality object configured for superimposition on image data obtained from a camera of the mobile device;
receiving user interaction data from the mobile device, the user interaction data relating to user interaction with the augmented reality object displayed in a composite view on a display of the mobile device in which the augmented reality object is superimposed on the image data;
analysing the validity of the received user interaction data including comparing the received user interaction data with an expected interaction; and,
if the received user interaction data is valid, authenticating the user.

11. The method as claimed in claim 10, wherein the user interaction data includes a recording of manipulation of the augmented reality object based on a mapping of movement of a body part of the user, identified in the image data, to manipulation of the augmented reality object being superimposed on the image data.

12. The method as claimed in claim 11, wherein analysing the validity of the received user interaction data includes analysing one or both of biometric and physical data associated with the body part and included in the image data.

13. The method as claimed in claim 10, wherein authentication of the user is associated with a predetermined physical environment.

14. The method as claimed in claim 10, wherein the interaction data includes the image data.

15. The method as claimed in claim 10, wherein analysing the validity of the user interaction data includes analysing the image data for the presence of a physical object which is known to be present in the physical environment which is required to be included in the image data for authentication of the user.

16. The method as claimed in claim 10, wherein analysing the validity of the received user interaction data includes analysing the image data for the presence of a fingerprint included in a camera with which the image data is obtained, and wherein the fingerprint is uniquely associated with the user.

17. The method as claimed in claim 10, wherein the set of data elements is transmitted to the mobile device of the user if the mobile device is determined to be within a predetermined threshold of a predetermined geographical location.

18. The method as claimed in claim 17, wherein the method includes:
receiving geographical location data from the mobile device; and,
using the geographical location data to determine whether the mobile device is within the predetermined threshold of the predetermined geographical location.

19. The method as claimed in claim 10, wherein the augmented reality object is a keypad and user interaction with the augmented reality object includes inputting a passcode into the keypad, wherein comparing the received user interaction data with an expected interaction includes:
analysing the user interaction data to determine the passcode input by the user; and
comparing the passcode to a passcode registered in association with the user.

20-21. (canceled)

22. A system for authenticating a user, the system including a mobile device of the user having a memory for storing computer-readable program code and a processor for executing the computer-readable program code, the mobile device comprising: a data element receiving component for receiving a set of data elements from an authentication server, the set of data elements relating to an augmented reality object configured for superimposition on image data obtained from a camera of the mobile device; an image data obtaining component for obtaining image data from the camera, the image data relating to a physical environment in which the mobile device is located;
a composite view display component for displaying a composite view on the display of the mobile device in which the augmented reality object is superimposed on the image data;
a user interaction data recording component for recording user interaction data relating to user interaction with the augmented reality object; and,
a user interaction data transmitting component for transmitting the user interaction data to the authentication server for validity analysis including comparison with an expected interaction for authentication of the user.

23. The system as claimed in claim 22, wherein the system includes an authentication server having a memory for storing computer-readable program code and a processor for executing the computer-readable program code, the authentication server comprising:
a data element transmitting component for transmitting a set of data elements to the mobile device of the user, the set of data elements relating to an augmented reality object configured for superimposition on image data obtained from a camera of the mobile device;
a user interaction data receiving component for receiving user interaction data from the mobile device, the user interaction data relating to user interaction with the augmented reality object displayed in a composite view on a display of the mobile device in which the augmented reality object is superimposed on the image data;
a validity analysing component for analysing the validity of the received user interaction data including comparing the received user interaction data with an expected interaction; and,
a user authentication component for, if the received user interaction data is valid, authenticating the user.

24-25. (canceled)
